(19) United States
(12) Patent Application Publication
(10) Pub. No.: US 2019/0156965 A1
(43) Pub. Date: May 23, 2019

(54) VALVE BLOCK FOR A PIGGABLE AND/OR SOLID-STATE CONDUCTING LINE SYSTEM AND DISTRIBUTION LINE SYSTEM

(71) Applicants: Pfeiffer Chemie-Armaturenbau GmbH, Kempen (DE); Kernkraftwerk Gösgen-Däniken AG, Däniken (CH)

(72) Inventors: Marcus Miertz, Wachtendonk (DE); Michael Miertz, Düsseldorf (DE); Bernd Riegler, Bergisch-Gladbach (DE); Leo Ornot, Oberentfelden (CH); Beat Bitterli, Kölliken (CH); Rainer Kaulbarsch, Brugg (CH); Lucien Conus, Starrkirch-Will (CH)

(73) Assignees: Pfeiffer Chemie-Armaturenbau GmbH, Kempen (DE); Kernkraftwerk Gösgen-Däniken AG, Däniken (CH)

(21) Appl. No.: 16/178,899

(22) Filed: Nov. 2, 2018

(30) Foreign Application Priority Data
Nov. 2, 2017 (DE) 10 2017 125 606.7

(51) Int. Cl. G21G 1/02; G21C 19/19; G21C 23/00; F16K 5/14

(52) U.S. Cl. CPC G21G 1/02; F16K 5/14; G21C 23/00; G21C 19/19

(57) ABSTRACT

A valve block for a piggable and/or solid-state conducting line system of a process technical plant can include one or more rotary control valves. The rotary control valve(s) can include one or more line inputs, one or more line outputs, and a rotatable control member with one or more through-channels. In an open position, a line input of the one or more line inputs is connected to a line output of the one or more line outputs through a through-channel of the one or more through-channels. In a closed position, the first control member separates the one or more line inputs from the one or more line outputs. The rotary control valves are rotatable about a same rotation axis and the control members are non-rotatably connected to each other. The one or more through-channels of respective rotary control valves are offset plane-parallel relative to each other in an axial direction of the rotation axis.

### CROSS REFERENCE TO RELATED APPLICATIONS

This patent application claims priority to German Patent Application No. 10 2017 125 606.7, filed Nov. 2, 2017, which is incorporated herein by reference in its entirety.

### BACKGROUND

The disclosure relates to a valve block for a piggable and/or solid-state conducting line system of a process technical plant, such as a nuclear power plant. The disclosure also relates to a distribution line system for a process technical plant, such as a nuclear power plant, in particular for harvesting radionuclides.

Radionuclides are used in many areas of technology and medicine, especially in nuclear medicine. To generate radionuclides, suitable stable nuclides are typically irradiated with neutrons. This results in unstable nuclides due to neutron capture, which are transformed back into stable nuclides by emitting alpha, beta, gamma or proton radiation via radioactive decay series. The irradiation with neutrons, also called nuclide activation, takes place mostly in research reactors, which are however mostly limited in capacity for the mass production of radionuclides. Alternatively, it was proposed to use commercial nuclear reactors used for energy generation as neutron sources for radionuclide production. To this end, it is planned to introduce so-called nuclide activation targets into one or more instrumentation fingers of a commercial nuclear reactor in order to be activated there by the radiation emitted by the nuclear fuel rods.

An example device and method for introducing and removing nuclide activation targets into and from a nuclear reactor is described in US 2013/0170927 A1. Accordingly, a loading branch is to be provided between a single instrumentation finger in the reactor core and a target reservoir and radionuclide harvest container arranged at a distance from the reactor core in order to provide a path from the instrumentation finger within the reactor core to either the target reservoir or the harvest container. The optional release of either one or the other path shall be adjustable by the position of a plunger with respect to a 90° T-junction. With the known device, it has turned out to be problematic that damage to the relatively brittle targets regularly occurs at this loading intersection, so that less material can be harvested and the distribution line system is contaminated by abrasion or fragments of the targets. Furthermore, the known device for harvesting nuclide activation targets is not economically viable, as the device is very large and the available space within the contamination area of the reactor building is limited. A further problem of the known device when used in existing reactors is that the building statics of the existing reactor building is only suitable to a very limited extent for the accommodation of additional devices. In the case of a reactor whose reactor core can be equipped with 10 to 50 instrumentation fingers, it is only possible with the known devices to set up a very small proportion of the existing instrumentation fingers with the known system for harvesting nuclide activation targets.

The instrumentation fingers used to pick up the targets are usually already existing tubes which run parallel to the nuclear fuel rods within the reactor core and are usually part of a so-called spherical or spherical shot measuring system for determining the power density distribution in the reactor core. In such a system, measuring spheres with activatable matter, for example vanadium, are filled into the instrumentation fingers of the reactor core for irradiation. Because their diameter is only slightly smaller than that of the instrumentation finger, the spheres in the fingers lie directly on or on top of each other like a chain. The spheres are activated by the radiation emitted by the nuclear fuel rods and, after a predetermined dwell time, are transported via a piping system from the reactor core area to a measuring device, the so-called measuring table, for the purpose of determining their activity. The pipe system including the instrumentation finger is self-contained and has a diameter in the area of the ball diameter, so that the sequence of the ball chain in the instrumentation finger is maintained during transfer to the measuring table. In this way, the spheres in the chain can be assigned to a respective longitudinal position of the nuclear fuel rods, which in turn allows conclusions to be drawn about the axial power density distribution of the neutron flux in the reactor core. Such a measuring system, also called ball measuring system or ball shot measuring system, with measuring device and corresponding pipe system is known from U.S. Pat. No. 3,711,714, for example. The knowledge gained from ball measurement serves reactor safety and is therefore usually mandatory at regular intervals. Basically, other measuring systems with instrumentation fingers and corresponding measuring bodies are also known which are used to measure other parameters which characterize the properties of the fuel rods and the conditions inside the reactor core.

While the measuring bodies for determining a specific property of the fuel rods or the conditions inside the reactor core, e.g. for determining the power density distribution, only dwell in the instrumentation finger for a few minutes each month, sufficient nuclide activation of the targets requires dwell times of several days or weeks. During this time, the instrumentation fingers used for radionuclide production are not available for measurement in the nuclide activation systems proposed so far. In addition, the nuclide activation systems proposed so far require an elaborate manual uncoupling and uncoupling of the respective instrumentation finger from the measurement system to the nuclide activation system and back again. Switching between nuclide activation and measurement is only possible with increased technical effort and creates an additional contamination risk when uncoupling and decoupling.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a schematic view of a distribution line system for a process plant which includes several valve blocks according to an exemplary embodiment of the disclosure;

FIGS. 2a-2f illustrates schematic diagrams of different positions of a rotary control valve with two or three through channels according to exemplary embodiments of the disclosure;

FIG. 3a illustrates a cross-sectional view of a distributor valve block according to an exemplary embodiment of the disclosure;

FIG. 3b illustrates a sectional view along section line II through a rotary control valve of the distributor valve block according to FIG. 3a; and

FIG. 4 illustrates a cross-sectional view of s closing block valve according to an exemplary embodiment of the disclosure.

The exemplary embodiments of the present disclosure will be described with reference to the accompanying drawings. In the drawings, the same or similar reference signs are used for identical or similar components.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

It is an object of the disclosure to provide a valve block and a distribution line system that requires only small space and low weight, and provides a particularly economical harvesting device for radionuclide targets with the lowest possible contamination risk at the same time.

Accordingly, in an exemplary embodiment, a valve block is provided for a piggable and/or solid-state conducting line system of a process technical plant, e.g. a nuclear power plant. In an exemplary embodiment, the valve block comprises at least two rotary control valves. A rotary control valve can, for example, be designed as a ball valve, plug valve or the like. A ball valve has a rotatable valve member with a truncated ball or ball outer surface which is rotationally symmetrical at least in sections. In an exemplary embodiment, a plug valve comprises a control member in the form of a rotationally symmetric truncated cone-shaped rotary body. Rotary control valves may also have other rotary control bodies with other outer surfaces which are at least partially rotationally symmetrical, e.g. cylindrical, truncated cone shaped, etc. The rotary control valves of the valve block each have at least one line input and at least one line output each, as well as a rotatable control member with at least one through channel. The control member with at least one through channel is arranged between the line input and the line output in order to connect the line input with the line output or to effect a separation between the line input and the line output. In an open position of the control member, the line input and the line output are connected through the through channel. In the open position, media carried by the line system, such as solids, pigs, fluids, such as conveying fluids, such as pneumatic fluids, in particular nitrogen, can move from the line outlet into the through-channel, through the through-channel, and out of the through-channel into the line outlet. In a closed position of the valve block, the control member separates the line input from the line output. In the closed position, the control member prevents the medium, such as a solid, a pig, or a fluid, such as a pumping fluid, such as nitrogen, carried in the line system from passing from the line input to the line output. In the closed position, the control member forms a solid-state and/or fluid-tight, in particular gas-tight, separation between the line input and the line output of the valve body.

In an exemplary embodiment, the at least two rotary control valves are rotatable about the same rotation axis and the control members of the at least two rotary control valves are non-rotatably connected to each other. If one of the rotary control valves of the valve block rotates by an angle, e.g. 10°, 30°, 45° or 90°, the second and any other rotary control valves of the valve block also rotate by the same angle with the same direction of rotation. In an exemplary embodiment, the at least one (first) through-channel of the first rotary valve is offset relative to the (first) through-channel of the second rotary valve in axial direction with respect to the axis of rotation. In an exemplary embodiment, the through channel of the first rotary control valve may be axially offset plane-parallel to the through channel of the second rotary control valve. In a valve block that includes three rotary control valves, four rotary control valves, or even more rotary control valves, the respective through channel(s) of each rotary control valve may also be offset axially to the through channel(s) of the remaining rotary control valves. For example, a first rotary control valve may have multiple through channels arranged in one plane and a second rotary control valve may have multiple through channels in a second plane, with the through channel planes of the first rotary control valve and the second rotary control valve offset from each other in the axial direction of the rotation axis. In an exemplary embodiment, the respective through-channel plane of a rotary control valve extends transversely (e.g. perpendicularly) to the axial direction of the axis of rotation.

A valve block according to an exemplary embodiment of the disclosure allows a compact and relatively simple design to provide a means within the piping system of a process technical plant, such as a nuclear power plant, of selectively guiding, for example, activatable and/or activated radionuclide targets, while at the same time providing secure protection against contamination by ensuring a secure seal of the piping system relative to the environment in both the open and closed positions of the rotary valve control member. The integration of multiple rotary control valves in a single valve block allows the number of actuators to be reduced to use multiple rotary control valves, simplifying both installation and operation of the system and significantly reducing space requirements compared to conventional systems.

According to an embodiment of a valve block, at least one of the rotary control valves has at least two line inputs and at least one control member with at least two through-channels, one of the through-channels being assigned to each of the at least two line inputs. The line inputs can be arranged offset relative to one another in the circumferential direction relative to the rotation axis of the rotary control valve and/or in the axial direction relative to the rotation axis of the rotary control valve. For example, a first line input of a rotary control valve can be offset by 90° relative to its second line input with respect to the axis of rotation and/or offset in the axial direction. With such a design, the two through channels, one of which is assigned to the first line input and the other to the second line input, can run through the control member without contact and/or obliquely to each other. In an exemplary embodiment, the through channels of a rotary control valve do not intersect or touch each other. The through channels can be arranged offset in axial direction and/or have a channel curvature so that they do not intersect each other.

According to an advanced configuration, the line inputs of the at least two rotary control valves of the valve block and the corresponding through channels can be arranged in such a way that the at least two through channels offset in axial direction connect their respective line inputs with a respective line output in the same position of the control member. This design allows further compacting of a valve block compared to conventional valve arrangements.

According to an embodiment of a valve block, in an active open position, an active through channel connects a line input to a line output. For example, the rotary control valve may have two, three or more line outputs, whereby in a first active open position, a first active through channel associated with the first line output connects the line output to a line input. In a second active open position, a second line output can connect the second line output to the second line input through an active through channel, which can be the first active through channel or a second through channel. In a third active open position, a third line output can be connected to a line input by an active through channel, which can be the first through channel, the second through channel or a third through channel of the rotary valve. In an exemplary embodiment, in the first active opening position, no through channel is available to connect a possible second, third or further line output to a line input. In each active open position, exactly one line output can be assigned to exactly one line input through an active through channel. For example, a rotary valve can be provided with a line input, three adjacent through channels and three line outputs, whereby depending on the position of the control member of the rotary valve, either the line input is connected to the first line output via a first through channel or to the second line output via the second through channel or to the third line output via the third through channel, whereby in the respective first, second or third position the line input is not connected to any further line output.

According to further embodiment of the valve block, the active through channel is especially dimensioned so that it is aligned with the line input and/or line output. In an exemplary embodiment, the through channel and the line input or through channel and the line output or line input and output have the same cross-section. In an exemplary embodiment, the through channel is aligned with the line input and/or line output without dead volume. In an exemplary embodiment, the through channel is coaxial to the line output and/or to the line input at the respective interface between through channel and line input or through channel and line output. It is conceivable that the line output is coaxial to the complete through channel and the line input. The advantage of a valve block for a piggable and/or solid-state conducting line system is that the transition from the line input to the through-channel or through-channel to the line output must be aligned as accurately as possible. This transition is particularly good sealing and therefore safe, and avoids wear and the accumulation of dirt in the transition area. Particularly with regard to radionuclides to be activated, which are frequently conveyed in the form of solid-state balls, it may be advantageous to design the through channel, the line input and/or the line output with, for example, a circular opening cross-section of the same size, slightly larger than the outer diameter of the (radionuclide) balls, in order to ensure efficient and low-wear conveyance of the balls through a coaxial and dead-volume free transition from the through channel to the line input and/or the line output. Such an alignment of the through-channel with the line input and/or the line output (e.g. of the same cross-section), coaxial and/or free of dead volume, can be realized in several rotary control valves of the valve block, in particular in all rotary control valves of the valve block.

When a rotary control valve is configured with one line input and two or three line outputs, it may be provided that one of the through channels extends in a straight line through the rotatable control member. The second through duct may extend with a curvature to connect the first line input in a second active open position to a second line input located relative to the first line input, offset, for example, 30° or 60° relative to the control member rotation axis. A third through channel may be configured to connect the line input to a third line output in a third active open position and to form a curved through channel for this purpose which extends to a third line output which is offset, for example, 30° or 60° from the first line output in the other direction. In the case of a rotary control valve with only two line outputs, it may be sufficient to provide a first and a second through channel, whereby only one of these two through channels can be curved and the other can be curved in a straight line or, in particular, mirror-inverted. In an exemplary embodiment, the radius of curvature of a through channel is considerably larger than the diameter of a radionuclide sphere, for example twice, five times, ten times or at least twenty times as large.

According to an embodiment of a valve block, at least one of the rotary control valves of the valve block is a distributor valve with at least one line input, at least two line outputs and at least two separate through-channels, in particular arranged in the same plane. The through channels of one rotary valve of the valve block are in particular separate in such a way that they do not cross, tangle, touch or the like. In an exemplary embodiment, the fluidic systems of the through channels are completely separated from each other in the rotatable control member of the valve block. In the distributor valve, the at least two line outputs are each assigned to the same line input or to different line inputs via a through channel. The distributor valve can have a first active open position in which the first through channel connects the line output with a first line output. The distributor valve may have a second active open position, in which a second flow channel connects one or other line input to a second line output. The manifold valve can have other third, fourth, etc. positions. The distributor valve may have opening positions in which a further third, fourth, etc. is provided. The third, fourth, etc. are provided with a respective third, fourth, etc. through channel, which connects the line input with a respective third, fourth, line output.

The disclosure also relates to a distribution line system for a process plant, such as a nuclear power plant, in particular for harvesting radionuclides, with at least one valve block according to one of the above requirements. The distribution line system may also comprise several valve blocks and specially designed valve blocks. For example, the distribution line system may include one or more distributor valves as described above. Alternatively or additionally, the distribution line system may include one or more valve blocks which have a pure open/close function without a distribution function (emergency closing valve). Purely closing rotary control valves are designed in such a way that the at least one through channel in the control member of the rotary control valve can assume a predetermined position in which a through channel from a line input to a line output is enabled and a second position in which none of the line inputs is connected to any line output. In particular, pure closing rotary control valves are designed in such a way that they do not connect a line input to a line output or to another line output.

It is conceivable, for example, that a distribution line system according to one or more exemplary embodiments of the disclosure has a distributor valve as described above, which, for example, has three line outputs per rotary control valve. In an exemplary embodiment, the valve block is equipped with several, for example two or three rotary control valves (e.g. of the same type). For example, the valve block comprises two or three distributor valves of the same type. The three line outputs of the rotary distributor valves of the valve block can each be followed by several closing rotary control valves, particularly in the form of a further valve block, for example three closing valve blocks each with exactly two or exactly three closing rotary control valves. With such a distributor line system, nine line outputs, for example nine individual receivers, such as instrumentation fingers of a reactor core, can be operated from three individual line inputs of the upstream distributor valve block. With such a distribution line system, a single distributor rotary control valve of an upstream distributor valve block can each be assigned to a downstream closing valve block, so that the instrumentation fingers or other receivers can be operated individually.

Alternatively, it is conceivable that the downstream closing valve blocks are arranged downstream of the upstream distributor valve block in such a way that, in the first active open position of the upstream distributor valve block, all the first line outputs of the plurality of distributor rotary control valves offset in the axial direction are actively assigned to the respective line input of the distributor rotary control valve of the first valve block, and that a three-strand closing valve block is assigned to the three first line outputs of the distributor valve block, so that three of nine instrumentation fingers are each simultaneously operated. In the same form, a second closing valve block is assigned to the three second line outputs of the manifold block, and a third closing valve block is assigned to the third line outputs of the manifold block.

According to a further embodiment of a distribution line system with at least one valve block as described above, the several, for example three, line outputs of this valve block are in fluid communication with an inner line system section, such as a high pressure section, for example a reactor core section. The several, for example three, line inputs of the valve block are in fluid communication with an outer line system section, such as a low pressure section, for example a reactor outer section, which may be provided within a contamination zone, for example a reactor. This valve block can, in particular, be realized as an emergency closing valve block for separating the inner line system section from the outer line system section. In an exemplary embodiment, metal seals are provided for an emergency closing valve block. The high pressure section may, for example, be intended for pipe pressures above 40 bar, in particular about 175 bar and/or a maximum of 500 bar or a maximum of 200 bar. The high pressure section can be designed for high temperatures from about 200° C. to about 500° C., in particular up to about 370° C. The high pressure section can be designed for high temperatures from about 200° C. to about 500° C. For example, a high-pressure section can be designed to withstand a leak between the reactor core and the instrumentation finger. The low-pressure section can, for example, be designed for pipe pressures up to 20 bar or up to 40 bar and/or for temperatures up to about 100° C. or up to about 200° C. The low-pressure section can also be designed for pipe pressures up to 20 bar or up to 40 bar and/or for temperatures up to about 100° C. or up to about 200° C. The low-pressure section can also be designed for pipe pressures up to 20 bar or up to 40 bar and/or for temperatures up to about 100° C. or up to about 200° C. A valve block designed as an emergency closing valve block of a distribution line system in accordance with the disclosure may be specially designed to reliably separate the area outside the reactor core from the area inside the reactor core in the event of a leakage at a receiver, for example an instrumentation finger in a reactor core, so that contamination of the area outside the reactor core by boiling water, steam or the like from the reactor core, in particular contaminated with highly radioactive particles, can be avoided.

Conventional devices, such as those described in US 2013/0170927 A1, do not have emergency closing valves or even an emergency closing valve block at a transition from a reactor high-pressure section to a reactor low-pressure section, so that a leakage at only one instrumentation finger can make it necessary to shut down the entire reactor system completely due to a malfunction. Only when the reactor is completely shut down can the pipe system connected with a leaking instrumentation finger in the area of a reactor boundary, in particular a reactor cover and/or a so-called cable bridge, be sealed, especially by manually attaching a sealing closing cap to a pipe connection. If, for example, a group of instrumentation fingers are in fluidic communication with each other through the fluidic connections, the leak at a single instrumentation finger will affect several fingers at once, all of which must be sealed, requiring individual seals of actually intact instrumentation fingers. If, in a system in which a distribution line system in accordance with the disclosure is used, several receivers, such as instrumentation fingers, are in fluid communication with each other, it may be advantageous to design distribution valve blocks and/or closing valve blocks in such a way that the line outputs of the distribution valve blocks and/or closing valve blocks are adjusted to receiving groups communicating with each other in fluid communication in such a way that the actuation of the receiver reduces the number of receivers as far as possible (e.g. only one), distribution valve blocks or as few as possible, or only one or only two, closing valve blocks, all receivers which are fluidically connected to one another are separated simultaneously (e.g. all the remaining receivers or at least the predominant part of the remaining receivers remaining unaffected by the separation of faulty receivers), such as a group of instrumentation fingers which are fluidically connected and one of which is leaking.

According to a further embodiment of the distribution line system, the valve block, in particular the emergency closing valve block, comprises several rotary control valves, in particular metal-sealing ball valves. In particular, the valve block can include less than ten, less than six, particularly less than five, in particular exactly two, exactly three or exactly four line outputs in fluid communication with the inner line system section. In an exemplary embodiment, the number of line outputs of the valve block in fluid communication with the inner line system section corresponds to a number of receivers communicating fluidly with each other, such as instrumentation fingers. A small number of less than ten line outputs, in particular six or four line outputs, can be realized in particular with a rotary control valve or emergency closing rotary control valve with exactly two integrated rotary control valves or exactly three integrated rotary control valves with exactly one or exactly two through channels each. It has been found that metal-sealing rotary control valves require a relatively high actuating force due to the very high static and sliding friction of a metal seal, so that it can be ensured that an actuator for actuating the (emergency-closing) valve block can be provided for a number of line outputs with assigned through channels as described above, which on the one hand ensures a safe movement from an active opening state and a closed (emergency-closing) state while at the same time ensuring relatively small installation space and weight.

According to a further embodiment of a distribution line system this includes at least one distributor valve block. In a process plant, such as a nuclear power plant, several such distribution line (sub)systems may be arranged in parallel and form a larger, branched distribution line system if more than nine receivers are to be served. For example, the parallel connection of three such distribution line (sub)systems may be provided to serve up to 27 receivers, such as instrumentation fingers. It is clear that not all line outputs need to be equipped with a receiver, but instead, for example, a seal, such as a lead seal, can also be provided as a bottleneck end, for example if the process plant to be operated has a smaller number of receivers than the distribution line system could serve. It is also conceivable that distribution line systems of different dimensions are connected side by side, for example two distribution line systems each with an upstream distributor valve block with three line inputs and nine line outputs (three first, three second and three third line outputs each). In addition, a further, differently dimensioned distribution line system may be provided, for example with a distributor valve block which has two or three line inputs and only six line outputs (either three first line outputs and three second line outputs according to a first alternative or two first line outputs, two second line outputs and two third line outputs according to a second alternative). Two closing valve blocks can be assigned to these six line outputs to operate six receivers, such as instrumentation fingers. Such a distribution line system would be designed for 24 receivers. In such a distribution line system—as described above—with 27 or 24 line outputs, the three distributor valve blocks upstream of the closing valve blocks can be preceded by a further distributor valve block, which can also be designed according to the disclosure, in order to serve the total of, for example, nine or eight line inputs of the distributor valve blocks described above, starting from, for example, three system line inputs. In the case of a distribution line system, it is also conceivable to arrange a further distribution device upstream of a distributor valve block or the line inputs of several distributor valve blocks, which need not be designed according to the disclosure.

According to a further embodiment of a distribution line system with at least one distributor valve block, at least one second distributor valve block may be provided. The second distributor valve block can be arranged parallel to the first distributor valve block as described above. Alternatively or additionally, an additional second or third distributor valve block can be connected in cascade with the first or second distributor valve block.

According to a further configuration of a distribution line system comprising at least one distributor valve, a distributor valve block as described above, or a distributor valve which does not necessarily have to be part of a distributor valve block, at least one line output of the at least one distributor valve block or distributor valve is in fluid communication with a ball measuring table and at least one other line output is in fluid communication with a radionuclide test station or a radionuclide bearing device. This additional distributor valve or distributor valve block has at least one line input which is aligned in the direction of the receiver, in particular the instrumentation finger(s), and serves for the targeted distribution of (radionuclide) balls from the receiver, such as the instrumentation finger(s) arranged in the reactor core, to the above-mentioned ball measuring table, the line output and/or the radionuclide harvesting station of the process plant.

Although the exemplary embodiments of a valve block or a distribution line system according to exemplary embodiments are described with regard to the use in a nuclear power plant, one of ordinary skill in the art will understand that other piggable and/or solid-state conducting line systems are also relevant and applicable to the present disclosure. A valve block according to one or more exemplary embodiments of the disclosure and/or a distribution line system according to one or more exemplary embodiments of the disclosure can, for example, also be used in a process plant, such as a chemical plant, e.g. a refinery, in particular an oil refinery, an oil pipeline, a food processing plant, a bulk material processing plant, a drug production plant or the like.

The solids to be conveyed from the line system or the distributor line system or the valve block can be, for example, balls, in particular balls with an outside diameter of 1 mm to 3 mm, for example about 1.7 mm. The line system or the through channel can have a clear width adapted to the material to be conveyed. The clear width is at least as large as, preferably slightly larger than, the material to be conveyed. For example, the clear width is at least 5%, at least 10% or at least 15% larger and/or not more than 50% larger, not more than 40% larger or not more than 30% larger than the outer diameter of a material unit. For example, the internal diameter of the pipe system and/or of a through channel may have an internal diameter of approximately 2 mm, in particular for conveying radionuclide spheres with a diameter of 1.7 mm. The line system can in particular be provided for the tubular mail-like conveyance of the solid body medium to be conveyed, such as balls, with a fuel, such as nitrogen, ambient air or the like, wherein the line system in such a configuration can be double-walled with an inner clear width which is matched to the conveyed material and an outer clear width for guiding the conveyed medium which is greater than the inner clear width. For example, the double-walled pipe may have an inner diameter of 2 mm and an outer diameter of 4 mm.

In a process plant in the form of a radionuclide activation plant, for example, balls containing or consisting of at least one of the following (not yet activated) nuclides may be provided as the solid medium to be conveyed: Mo-98, Yb-176, V-51.

The materials described in WO 2016/120120 A1 may also be considered as solid materials for conveyance in such a plant. Furthermore, the materials described in WO 2016/119862 A1 can be considered as solid materials for guidance in such a plant. In addition, the materials described in WO 2016/119864 A1 may be considered as solids for such a plant.

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

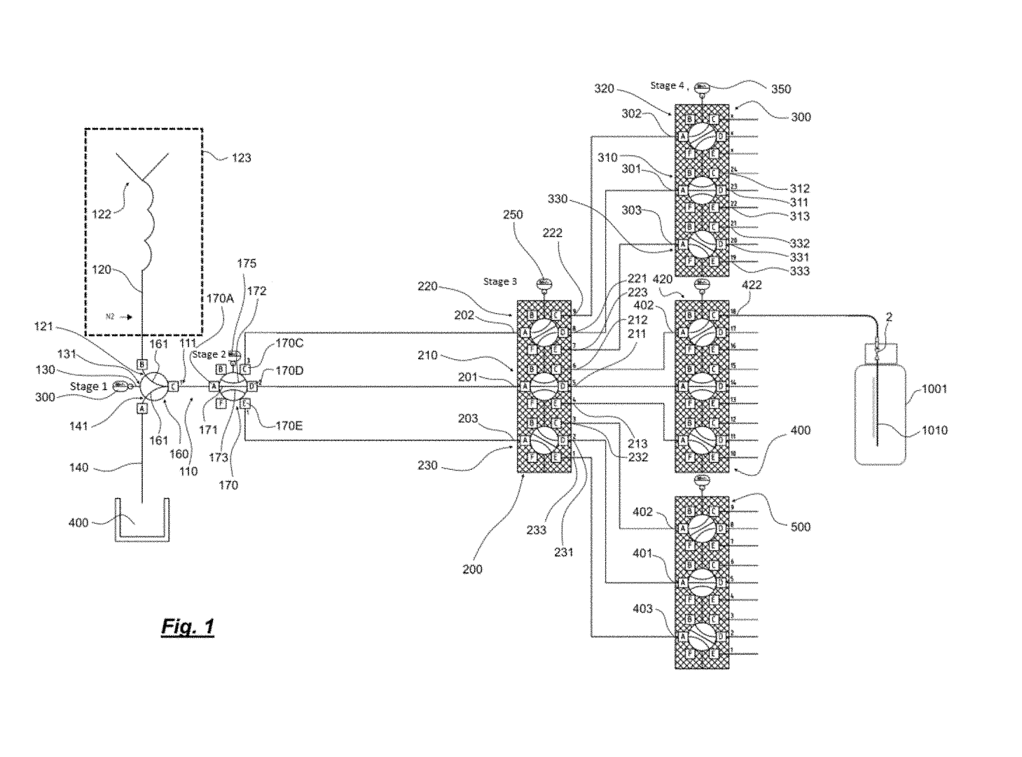

FIG. 1 shows a schematic representation of a distribution system 100 according to an exemplary embodiment of the disclosure for a process plant, for example for the optional transfer of nuclide activation targets and measuring bodies into or from an instrumentation finger of a commercial nuclear reactor (not shown in detail). For example, the system allows, on the one hand, to comply with the operational regulations for carrying out so-called ball-shot measurements, which serve to determine the power density distribution or neutron flux in the reactor core, and, on the other hand, to use the radiation emitted by the nuclear fuel rods to irradiate nuclide activation targets in the intermediate measurement-free periods.

In an exemplary embodiment, the line system 100 for receiving and transporting the measuring bodies and targets includes several line branches 110, 120, 130, 140 which lead into a multi-way fitting 160 and which can optionally be brought into flow connection with one another via the switchable multi-way fitting 160. In this example, the line system 100 comprises a reactor branch 110 which is coupled to (not shown in detail) receivers, such as instrumentation fingers, in a reactor core via end couplings in the form of the closing valve blocks 2 described below. In an exemplary embodiment, the line system 100 further includes a reservoir branch 120 for intermediate storage of the measuring bodies or targets, as well as a measuring branch 130 coupled to a measuring device 300, in particular a so-called measuring table known from U.S. Pat. No. 3,711,714, for determining the activity of the measuring bodies. Furthermore, the line system 100 can include an insertion branch (not shown in detail) which can be coupled to an insertion device, such as a transport container, in order to introduce new, unirradiated targets into the line system 100.

For the removal of irradiated targets, the line system 100 also has a removal branch 140, via which the irradiated targets can be transferred to a removal container 400. All branches 110, 120, 130, 140 of the line system flow into the distributor valve or the multiway fitting 160 like a node point. For pneumatic transport of the measuring bodies and targets, the distributor system 100 has a pneumatic transport device (not shown in detail). In an exemplary embodiment, nitrogen is the transport gas, but is not limited thereto.

To activate the targets, i.e. to convert them into radionuclides, they are held in the instrumentation finger, typically for several days to weeks. If a ball shot measurement becomes necessary during this time due to operational safety regulations, the targets can be temporarily parked in the reservoir branch 120. For this purpose, transport gas is introduced into a finger gas line, whereby the partially activated targets are transferred from the instrumentation finger via the reactor branch 110 and the multiway valve 160 into the reservoir branch 120. In an exemplary embodiment, for radiation protection reasons, section 122 of the storage branch 120, in which the partially irradiated targets are parked, is equipped with a shielding 123 against ionizing radiation.

For the ball-shot measurement to be carried out, the multi-way fitting 160 is then moved to the second switching position. Transport gas is then introduced into the measuring device 300 in order to transfer the measuring bodies via the measuring branch 130, the multiway fitting 160 and the reactor branch 110 into the instrumentation fingers. After irradiating the measuring bodies, they are transferred from the instrumentation finger via the reactor branch 110, the multi-way valve 160 and the measuring branch 130 back to the measuring device 300 by means of transport gas. There the activity of the irradiated measuring bodies can be measured to determine the power density profile of the reactor.

As soon as the measuring bodies are in the measuring device 300, the activation of the partially irradiated targets can be continued. The targets are transferred from the reservoir branch 120 back into the instrumentation finger 1010 according to the procedure described above.

After complete activation of the targets, they are first transferred to a section of the reactor branch 110, the length of which corresponds at least to the length of the chain of the targets lined up in the line system, in order to be removed from the line system. Then the multiway fitting 160 is set to connect the reactor branch 110 with the extraction branch 140. In an exemplary embodiment, the targets are transferred pressurelessly and exclusively gravitationally driven from the reactor branch 110 via the multiway armature 160 and a sampling branch 140, which can be arranged vertically underneath, and in particular falls monotonously, into the sampling vessel 400.

The reactor branch 110, which starts from the multiway fitting 160, branches out to the instrumentation fingers, which are not shown in more detail. In this example, the receivers of the distribution line system 100 are realized in such a way that, for example, 24 individual instrumentation fingers can be operated from the multiway fitting 160. The ramification of the reactor branch 110 is realized by a cascade-like series connection of distribution components arranged one behind the other.

In an exemplary embodiment, the multi-way fitting 160 is initially followed by a distributor valve 170, which in the embodiment shown only includes a single rotary valve. This rotary valve is essentially formed like the multi-way fitting 160. For example, a 170A line input can be provided on the 170 distributor valve to lead from the 160 multiway fitting further into the 110 reactor branch. In an exemplary embodiment, the distributor valve 170 has three through channels 171, 172, 173 located in the same control member of the single rotary valve (e.g. in the same horizontal plane). Each of these three through channels 171, 172, 173 is specifically assigned a line output 170C, 170D, 170E of the manifold valve 170.

In an exemplary embodiment, the distributor valve 170 includes a line input 170A, which can be fluidically connected to exactly one of the three line outputs 170C, 170D or 170E, depending on the position of the control member of the distributor 170, in order to convey solids to be conveyed in the distributor line system 100, for example radionuclide balls. The valve member of the distributor valve 170 can assume several conveying positions, in the example shown exactly three. In the first conveying position, the first through channel 171 connects the line input 170A with the first line output 170D. In the second position, the second through channel 172 connects the line input 170A to the second line output 170C. In the third position, the third through channel 173 connects the line input 170A with the third line output 170E. The 170 distributor valve of the 110 reactor branch can be described as a 1/3-way valve. The distributor valve 170 is equipped with an actuator 175, for example a pneumatic or electric adjusting drive, which actuates the valve 170 to take one of the positions described above. A first distributor valve block 200 is connected to the line outputs 170C, 170D and 170E of the distributor valve 170.

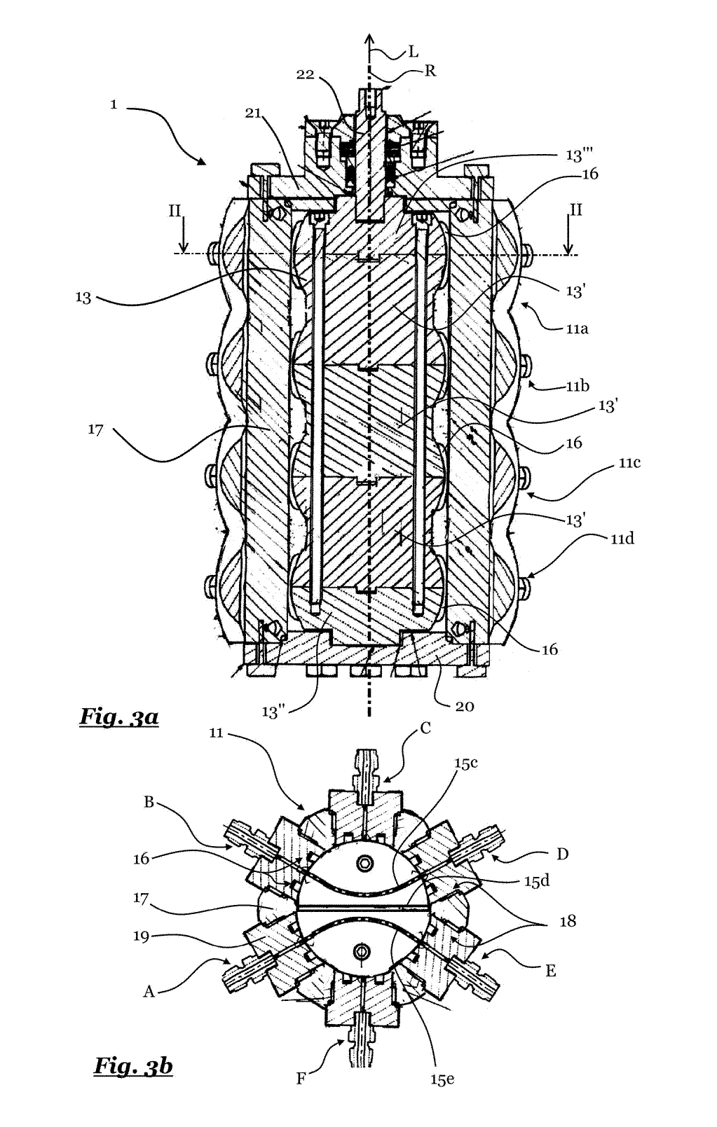

The first valve block 200 comprises three coupled rotary control valves 210, 220, 230. The structure of an exemplary distributor valve block is described in detail below with regard to FIGS. 3a and 3b. The three distributor valves 210, 220, 230, which are assembled to form the distributor valve block 200, have essentially the same design as the previous distributor valve 170.

The first line output 170D of the distributor valve 170 leads to the line input 220A of the first distributor valve 210 of the distributor valve block 200. The second line output 170C of the distributor valve 170 leads to the second distributor valve 220 of the distributor valve block 200. The third line output 170E of the distributor valve 170 leads to the third distributor valve 230 of the distributor valve block 200. Each of the distributor valves 210, 220 and 230 of the distributor valve block 200 has a similar design. The control members of valves 210, 220 and 230 are non-rotatably connected to each other by a common control rod and are actuated by a common actuator 250. The actuator 250 of the first distributor valve block 200 can, for example, be a pneumatic or electric actuator. It is conceivable that the actuator 250 (or 175) has a limited range of rotation, for example up to ±60°, up to ±90° or up to ±120°. In an exemplary embodiment, the actuator 250 of the distributor valve block 200 is more powerful than the actuator 175 of the distributor valve 170 in order to take into account the significantly increased sliding resistances of the several jointly actuated rotary actuators of the valve block 200 in comparison with the individual rotary actuators of the simple ⅓-way valve 170.

Like the distributor valve 170 described above, the distributor valves 210, 220 and 230 of the distributor valve block 200 have a respective line input 201, 202, 203 and three respective line outputs, as well as a corresponding number of through channels in the respective control member of a distributor valve. Depending on the position of the control member, a through channel of the control member connects one of the respective line outputs with the respective line input. The valve block 200 has nine line outputs.

In an exemplary embodiment, due to the torsionally rigid connection between the control members, the individual control valves 210, 220 and 230 of valve block 1 to be matched to each other in such a way that they assume corresponding positions. FIG. 1 shows different positions of the valve elements for the individual control valves of the control valve block 200 for illustration purposes only. In an exemplary embodiment, the individual control valves of a control valve block 200 are matched to one another in such a way that in a first block switching position the line input 201, 202 or 203 of all control valves 210, 220, 230 is connected to a first line output 211, 221 or 231, in a second block switching position the line input 201, 202 or 203 is connected to a second line output 212, 222 or 232 and in a third block switching position the line input 201, 202 or 203 is connected to a third line output 213, 223 or 233.

In an exemplary embodiment, three further distributor valve blocks 300, 400, 500 of the same type are connected to the line outputs of the first distributor valve block 200. In an exemplary embodiment, the distributor valve blocks 300, 400, 500 are structured exactly like the previous distributor valve block 200 and function in the same way. Consequently, there is no redundant description of the individual components and functions of the second valve blocks 300, 400, 500. The same components have reference signs increased by the number 100.

As shown in FIG. 1, a distribution line system 100 according to an exemplary embodiment may be configured such that the line inputs of one of the second distribution valve blocks 300, 400, 500 are connected to the line outputs of a single distribution valve 210, 220 or 230 of the first distribution valve block 200. In an exemplary embodiment, a different arrangement or connection of the valve block and the second valve blocks may be used. For example, a first downstream (second) valve block (e.g. 300) may be connected (not shown) to the three first outputs 211, 221, 231 of different distributor valves of the first valve block 200. A second downstream (second) valve block (e.g. 400) can be connected to the second outputs 212, 222, 232 of the first valve block 200 and a third downstream (second) valve block (e.g. 500) can be connected to the third line outputs 213, 223, 233 of the first valve block 200.

The second distributor valve blocks 300, 400 and 500 can also be configured differently from the first distributor valve block 200. For a simplified illustration, an example illustration has been selected in FIG. 1 in which all distributor valve blocks 200, 300, 400 and 500 are identical. The distribution valve blocks 300, 400 and 500, arranged in the second cascade row, each have three line inputs 301, 302, 303; 401, 402, 403; as well as 501, 502 and 503. Three line outputs are assigned to each of the line inputs via a respective rotary control valve. In total, the distributor valve blocks arranged in the second cascade row provide 27 line outputs, from which individual receivers, for example instrumentation finger 1010 in a reactor core 1001 can be operated (an instrumentation finger is shown schematically).

In the example shown, 24 individual receivers are provided. Therefore, several, here three, line outputs are sealed, namely the line outputs of the second rotary control valve 320 of the first distributor valve block 300 in the second cascade row. Alternatively, it would be conceivable to provide a seal directly at the second output 222 of the second control valve of the first valve block 200 and to provide a smaller control valve block with, for example, only two control valve levels instead of the illustrated control valve block 300.

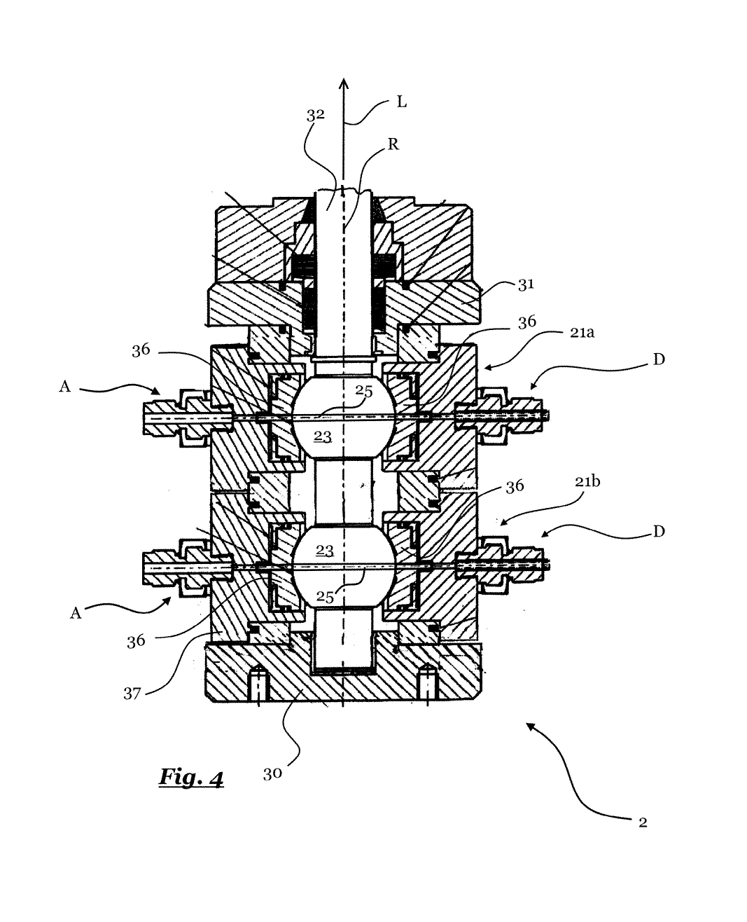

Between the outputs of the distributor valve blocks of the second cascade stage 300, 400 and 500 and the respective receiver, for example a reactor core instrumentation finger, an emergency closing valve, for example in the form of an inventive emergency closing valve block 2 as described in detail below with respect to FIG. 4, can be provided for providing a system boundary (here only schematically illustrated for an instrumentation finger 1010).

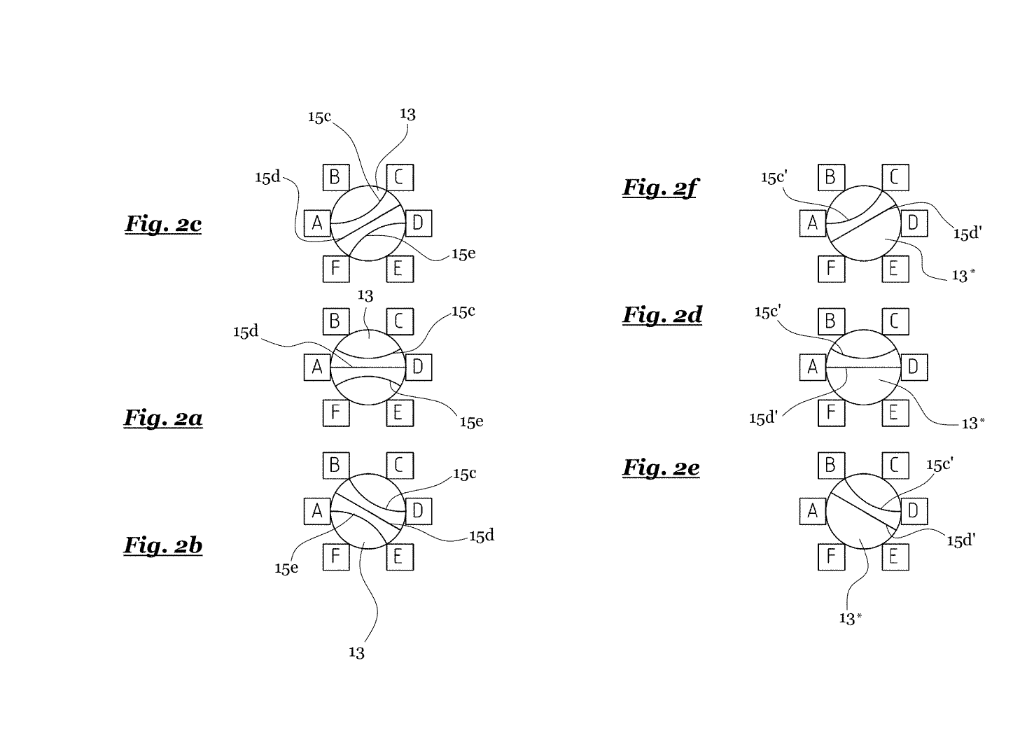

FIGS. 2a, 2b. 2a, 2b and 2c show switching positions for a control valve according to the positions shown for valve blocks 200, 300, 400 and 500 in FIG. 1. In an exemplary embodiment, in contrast to the figure according to FIG. 1, it is conceivable that, in addition to one line input A, further line inputs B, F are provided. In the example shown in FIG. 2a to FIG. 2c, three line outputs C, D and E are provided. FIG. 2a shows a first active position in which the first valve input A is connected to the first valve output D by a first through channel 15d, which extends through the actuator 13 of the control valve 200. The other two through channels 15c and 15e in valve member 13 are not connected to a line input or line output in this first active position.

FIG. 2b shows a second switching position in which the first line input A is connected to a second line output E via a curved through channel 15e. The curvature corresponds approximately to the radius of the actuator ±50%. The first through channel 15d is neither in contact with a line input nor with a line output. The third through channel 15c, which runs mirror-inverted with reversed curvature relative to the second through channel 15e through the actuator 13, connects a second line input B with the first line output D. The second line input B is in contact with the first line output D. The first line output D is connected to the second line input B. The control member 13 closes the third line input F and the third line output C. The second line input B is connected to the first line output D by the control member 13.

In the third switching position of the valve shown in FIG. 2c, the third through channel 15c connects the first line input A with the third line output C. The third line input F is connected to the third line output D with the through channel 15e. The third line input F is connected to the through channel 15e with the first line output D. The second line input B is connected to the third line output C. The second line input B and the second line output E are closed. There are no line inputs and/or outputs in contact with the first through channel 15d.

FIGS. 2d, 2e and 2f show an alternative embodiment of a rotary control valve with three line inputs A, B and F and three line outputs D, C and E and one control member 13* in which exactly two through channels 15d′ and 15c′ are provided. The through channels 15d′ and 15c′ correspond to the previously described through channels 15d and 15c of FIGS. 2a to 2c. With regard to the switching positions illustrated in FIGS. 3d to 3f, reference is made to the switching position described above.

In the positions illustrated in FIGS. 2d, 2e and 2f, the third line input F is always closed, as is the second line output E. It is conceivable that only the first and second line inputs A and B and the first and third line outputs D and C, i.e. only two line inputs and two line outputs, are provided for such a control valve. Alternatively, it is conceivable that the control valve can assume further positions (not illustrated) similar to those illustrated in FIGS. 2d and 2f, but with the valve element 13* in a mirror image switching position, in order to connect the third line input F or the second line output E with at least one of the other line inputs or line outputs.

FIG. 3a and FIG. 3b show the valve block 200 according to an exemplary embodiment, which includes four axially offset rotary control valves in the form of ball valve valves 11. The valve block 1 comprises four ball valve valves 11a, 11b, 11c, 11d which are rigidly connected to each other.

It is conceivable that the ball valves 11 are manufactured by 3D printing or the like. The illustrated ball valves 11 are manufactured according to the principle of the split ball, i.e. each ball valve is split in a plane perpendicular to the rotation axis R (e.g. the section plane II), and at the section plane the surfaces of one half of the ball or the surfaces of both halves of the ball are machined, for example by milling, into the through channels 15d, 15c and 15e.

As shown in FIG. 3a, the ball valve elements 13 are stacked on top of each other along the axis of rotation R. The valve block 200 has a composite control member for the four ball valves 11a to 11d. The valve block 200 has an assembled control member for the four ball valve valves 11a to 11d, which is composed of five parts, namely above and below a hemisphere 13′″, 13″ and three in particular similar double ball halves 13′, which each have a flat side on their upper side and their lower side in which the through channel can be formed.

The cover hemisphere 13′″, the three double hemispheres 13″ and the base hemisphere 13″ are non-rotatably connected to each other by connecting screws which extend transversely through all hemisphere halves and/or by form-fit pairs.

In the horizontal plane, in which the through channels 15c , 15d , 15e extend, the ball halves have their largest outer diameter. In the direction of the longitudinal axis L above and below this respective plane, the outer circumference of the ball halves narrows relative to the rotation axis R. In the circumferential area surrounding the inlet or outlet of the through channels 15c , 15d or 15e , the valve members 13 are each equipped with at least one sealing element 16. The sealing element 16 extends around a respective ball valve member and/or annularly around an inlet or outlet of the through channel 15c , 15d , 15e . In an exemplary embodiment, the seals 16 are non-rotatably connected to the housing 17, which surrounds the control members 13. The seals 16 are used to transfer a conveying fluid loss-free between line inputs A, B, F and line outputs C, D, E. They are also used for the purpose of a rotationally fixed connection to the housing 17. They also serve the purpose of ensuring a sealing closure in a closed position of the control member 13.

The housing 17 surrounding the ball valve members 13 has a substantially hollow cylindrical shape. For the line inputs A, B, F and the line outputs C, D and E, passages are provided through the wall of the housing 17. For example, the housing 17 can have threaded holes 18, into each of which a cable connector 19 is screwed. At the radially inner end of a line connector 19, there can be a receptacle for the annular sealing element 16. A mounting adapter can be provided at a line connector 19 for easier attachment of lines from an existing distribution line system of a nuclear power plant or the like. At each end of the housing 17 in axial direction L, a closing flange 20 can be attached on one side and a drive adapter flange 21 on the other side. The closing flange 20 can, for example, be fastened to the sleeve body of the housing 17 by means of screws and have a plain bearing receptacle for fixing the ball valve body 13 in the axial and radial directions.

A screw connection can be provided on the drive adapter flange 21 to fasten the drive adapter flange 21 to the valve housing 17. In an exemplary embodiment, the drive adapter flange 21 is equipped with a bearing, such as a slide bearing, for axial and/or radial holding of the frontal ball valve hemisphere 13″. In an exemplary embodiment, the drive adapter flange 21 includes one or more receptacles for seals and a passage for a drive shaft 22 for actuating the valve elements 13. The drive shaft 22 extends into the valve housing 17 and is positively engaged with the ball valve elements 13. In particular, the end face hemisphere 13″' can have a positive receptacle for one end of the drive shaft 22.

The ball valve halves 13′, 13″ and 13″' in the embodiment shown in FIG. 3a are solid bodies. With the exception of the through channels 15c , 15d and 15e and the through holes for the fastening screws as well as any recesses to accommodate positive locking projections of other ball sections, they are solid without recesses. Such a solid and robust structure is particularly suitable for high-pressure and/or high-temperature conditions, for example in a nuclear power plant.

It is conceivable that for other fields of operation, the control members of a ball valve are formed less solidly, for example in a lightweight design, or are even formed merely from through-duct pipes with structural and/or connecting components such as struts, ribs or the like.

Sealing elements 16 can be formed, for example in the low-pressure range (e.g. below 40 bar, below 100° C.) of a nuclear power plant, as soft seals, e.g. from PTFE or another suitable plastic.

For a high-temperature and/or high-pressure range (e.g. over 40 bar, over 100° C.), seals which can withstand higher pressures and/or temperatures, such as metal seals, graphite seals or similar, are to be preferred.

FIG. 4 shows an exemplary embodiment of a valve block 2, which is designed as an emergency closing valve block. In an exemplary embodiment, the emergency closing valve block 2 includes two rigidly connected, solid ball valve elements 23, through each of which a through channel 25 is drilled. With this design, the passage 25 can extend in a straight line and purely radially, i.e. crossing the axis of rotation R, across the center of the valve member 23.

With the emergency closing valve block 2 shown in FIG. 4, the ball valve elements are manufactured in one piece with the drive shaft 32, for example forged, rolled, milled and/or machined from one piece.

Such an emergency closing valve block 2, for example, is well suited as an emergency closing valve block 2 for the safe fluidic separation of instrumentation fingers (not shown), so that no radioactively contaminated fluids, gases and/or vapors can penetrate from a leaking instrumentation finger into the rest of the system.

For this purpose, an emergency closing valve block 2 may be formed close to an inner shell of a reactor core 1001 immediately adjacent to the inner shell of the reactor core or even as part of the shell of the reactor core. In an exemplary embodiment, in order to safely withstand high pressures, for example above about 40 bar and/or high temperatures above 200 ° C., in particular 300-400° C., the seals 36 of the emergency closing valve block 2 are formed as metal seals. The metal seals 36 are pressed against the ball valve control members 23 with a high radial contact pressure, so that high contact pressures and friction forces occur at the spherical circumference of the ball valve 2. The high friction forces act in the form of torsional forces against the actuating force applied to the control member shaft 32. In an exemplary embodiment, therefore less than five, less than three, or only exactly two ball valve elements 23 are formed on one control member shaft 32. The number of ball valve elements 23 formed are not limited to these example quantities.

In an exemplary embodiment, the ball valve elements 23 of the ball valves 21a and 21b of the emergency closing valve block 2 are equipped with straight through channels 25. It is conceivable that in the axial direction L there is an offset with respect to each other and with respect to the axis of rotation R there is an angular offset with respect to each other of several through-channels, for example two, in a single ball valve member (not shown in detail). For example, two through channels 25 extending in a straight line through the center of the ball valve control member 23 may be provided which are offset by 90° from each other in the axial direction over more than one channel diameter and/or relative to the axis of rotation R.

In an exemplary embodiment, the housing 37 of the emergency closing valve block 2 is realized similar to the housing 17 of the distributor valve block 200 described above. For example, it can be composed of a multi-part sleeve body 37, in particular, as well as a closing cover attached to the axial foot end and a drive adapter end 31 attached to the opposite front end, similar to the flange parts 20, 21 described above. In an exemplary embodiment, the end pieces 30, 31 are equipped with an axial and/or radial bearing for the output shaft 32.

In a multi-part sleeve body of the housing 37, connection pieces and in particular distribution line system duct connections can be fitted in the radial direction, for example screwed in.

The features disclosed in the above description, the figures and the claims may be relevant, either individually or in any combination, to the realization of the disclosure in its various embodiments.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure.

Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

2 emergency closing valve block

11a, b, c, d ball valve

13, 13*, 13′, 13″, 13′″ control member

15c, d, e, c′, d′, e′, 25 through channel

16 sealing element

17, 37 housing

18 threaded hole

19 lines connector

20 closing flange

21 drive adapter flange

21a, 21b ball valve member

22, 32 drive shaft

20 reservoir branch

23 valve member

31 drive adapter end

32 adjusting shaft

100 distribution system

110, 120, 130, 140 line branches

122 section

123 shielding

160 multiway fitting

170 distribution valve

170c, d, e line output

170A line input

171, 172, 173 through channel

175 actuator

200, 300, 400, 500 distributor valve block

201, 202, 203; 301, 302, 303 line input

401, 402, 403; 501, 502, 503 line output

210, 220, 230 rotation control valve

211, 221, 231 line output

212, 222, 232 line output

213, 223, 233 line output

220A line input

222 output

250 actuator

1001 reactor core

1010 instrumentation finger

A, B, F line input

C, D, E line output

L longitudinal axis

R rotation axis

1. A valve block for a piggable and/or solid-state conducting line system of a process technical plant, comprising:
a first rotary control valve, the first rotary control valve including one or more first line inputs, one or more first line outputs, and a first rotatable control member with one or more first through-channels, wherein, in an open position of the first rotatable control member, a line input of the one or more first line inputs is connected to a line output of the one or more first line outputs through a through-channel of the one or more first through-channels, and in a closed position, the first control member separates the one or more first line inputs from the one or more first line outputs; and
a second rotary control valve, the second rotary control valve including one or more second line inputs, one or more second line outputs, and a second rotatable control member with one or more second through-channels, wherein, in an open position of the second rotatable control member, the a line input of the one or more second line inputs is connected to a line output of the one or more second line outputs through a through- channel of the one or more second through-channels, and in a closed position, the second control member separates the one or more second line inputs from the one or more second line outputs, wherein:
the first and the second rotary control valves are rotatable about a same rotation axis and the first and the second control members of the first and the second rotary control valves are non-rotatably connected to each other; and
the one or more first through-channels of the first rotary control valve and the one or more second through-channels of the second rotary control valve are offset plane- parallel relative to each other in an axial direction of the rotation axis.

2. The valve block according to claim 1, wherein the first rotary control valve further comprises another line input, wherein the first control member includes another through- channel, the first through-channel and the other through-channel being respectively assigned to the first and the other line inputs.

3. The valve block according to claim 1, wherein, in the open position of the first rotatable control member, an active one of the first through-channel connects an active one of the one or more first line inputs to an active one of the one or more first line outputs, the active one of the one or more first through-channels being aligned with the active one of the one or more first line inputs and/or the active one of the one or more first line outputs of a same cross-section, coaxially, and/or without dead volume.

4. The valve block according to claim 3, wherein, in the open position of the second rotatable control member, an active one of the second through-channel connects an active one of the one or more second line inputs to an active one of the one or more second line outputs, the active one of the one or more second through-channels being aligned with the active one of the one or more second line inputs and/or the active one of the one or more second line outputs of a same cross-section, coaxially, and/or without dead volume.

5. The valve block according to claim 1, wherein the first and the second rotary control valves is a distributor valve having at least one line input, at least two line outputs and at least two separate through-channels arranged in a same plane, the distributor valve having a first active open position, in which a first of the at least two separate through channels connects the at least one line input to a first line output of the at least two line outputs, wherein the distributor valve has a second active open position in which a second of the at least two separate through channels connects the at least one line input to a second line output of the at least two line outputs.

6. A distribution line system for a process technical plant having a valve block for a piggable and/or solid-state conducting line system of a process technical plant, the valve block comprising:
a first rotary control valve, the first rotary control valve including one or more first line inputs, one or more first line outputs, and a first rotatable control member with one or more first through-channels, wherein, in an open position of the first rotatable control member, a line input of the one or more first line inputs is connected to a line output of the one or more first line outputs through a through-channel of the one or more first through-channels, and in a closed position, the first control member separates the one or more first line inputs from the one or more first line outputs; and
a second rotary control valve, the second rotary control valve including one or more second line inputs, one or more second line outputs, and a second rotatable control member with one or more second through-channels, wherein, in an open position of the second rotatable control member, the a line input of the one or more second line inputs is connected to a line output of the one or more second line outputs through a through- channel of the one or more second through-channels, and in a closed position, the second control member separates the one or more second line inputs from the one or more second line outputs, wherein:
the first and the second rotary control valves are rotatable about a same rotation axis and the first and the second control members of the first and the second rotary control valves are non-rotatably connected to each other; and
the one or more first through-channels of the first rotary control valve and the one or more second through-channels of the second rotary control valve are offset plane- parallel relative to each other in an axial direction of the rotation axis.

7. The distribution line system according to claim 6, wherein the one or more first line outputs and/or the one or more second line outputs are in fluidic communication with an inner line system section, and the one or more first line inputs and/or the one or more second line inputs are in fluidic communication with an outer line system section, wherein the valve block is an emergency closing valve block configured to separate the inner line system section from the outer line system section.

8. The distribution line system according to claim 7, wherein the first and/or second rotary control valves is a metal-sealing ball valve, and wherein the valve block comprises exactly 2, 3 or 4 line outputs in fluid communication with the inner line system section.

9. The distribution line system (100) according to claim 6, wherein at least one of the first and the second rotary control valves is a distributor valve having at least one line input, at least two line outputs and at least two separate through-channels arranged in a same plane, the distributor valve having a first active open position, in which a first of the at least two separate through channels connects the at least one line input to a first line output of the at least two line outputs, wherein the distributor valve has a second active open position in which a second of the at least two separate through channels connects the at least one line input to a second line output of the at least two line outputs.

10. The distribution line system according to claim 9, wherein each of the first and the second rotary control valves are distributor valves, wherein the distributor valves are connected in in series in a cascade arrangement.

11. The distribution line system according to claim 9, wherein at least one line output is in fluid communication with a ball measuring table and of which at least one other line output is in fluid communication with a radionuclide harvesting station or a radionuclide bearing device.

12. The valve block according to claim 1, wherein at least one of the first and second rotary control valves is a ball valve.

13. The valve block according to claim 1, wherein at least one of the first and second rotary control valves is a plug valve.

14. The valve block according to claim 1, wherein the process technical plant is a nuclear power plant.
